(19) United States
(12) Patent Application Publication
(10) Pub. No.: US 2016/0149704 A1
(43) Pub. Date: May 26, 2016

(54) METHOD AND APPARATUS FOR PARALLEL SCALAR MULTIPLICATION

(71) Applicant: Umm Al-Qura University, Makkah (SA)

(72) Inventor: Turki F. AL-SOMANI, Makkah (SA)

(73) Assignee: Umm Al-Qura University, Makkah (SA)

(21) Appl. No.: 14/952,144

(22) Filed: Nov. 25, 2015

Related U.S. Application Data
(60) Provisional application No. 62/084,409, filed on Nov. 25, 2014.

(51) Int. Cl. H04L 9/30; G06F 7/72

(52) U.S. Cl. CPC H04L 9/3066; G06F 7/725

(57) ABSTRACT

An efficient method of parallel-scalar multiplication to obtain the scalar product between a key and a point on an elliptic curve, using parallel processors. In selected embodiments, the key is partitioned into a number of partitions equal to the number of parallel processors. Precomputed points of the point on the elliptic curve are obtained using point-doubling operations, wherein the number of precomputed points also equals the number of parallel processors. Using a binary scalar-product method, intermediate scalar products are obtained when each of the parallel processors computes in parallel the scalar product between a key partition and a corresponding precomputed point. These intermediate scalar products are then aggregated using point-addition operations to obtain the total scalar product of the key and the point.

### CROSS-REFERENCE TO RELATED APPLICATIONS

This patent application is based on and claims priority to U.S. provisional patent application No. 62/084,409, filed on Nov. 25, 2014, the entire contents of which are hereby incorporated by reference herein.

### BACKGROUND

Cryptography systems are commonly used for providing secret communication of a text message or a cryptographic “key,” or for authenticating identity of a sender via a digital signature. Once encoded, information is generally stored in a computer file (on a disk, for example) or transmitted to a desired recipient. So-called “public key cryptography” uses two asymmetric “keys,” or large numbers, consisting of a public key and private key pair. If the public key is used to encode information according to a known algorithm, then the private key is usually needed by the recipient to decode that information, and vice-versa. Public key cryptography relies upon complex mathematical functions by which the public and private keys are related, such that it is extremely difficult to derive the private key from the public key, even with today's high speed processing computers.

One type of public key cryptography system is based upon elliptic curve representations and related mathematics and processing. As an end product of such processing, at least one coded block of information is created and represented as a data point having both X and Y coordinates, with each coordinate being a number between zero and 2N −1; if a large quantity of information is to be enciphered, there may be many such points, each point represented by at least 2N bits of information.

In these cryptographic systems, a finite field is also chosen, i.e., F₂_{^{N}}, where N denotes the number of binary bits used by a computer to represent an element of the finite field. An irreducible generator polynomial or order N is then selected which defines the arithmetic operations in the field. The coefficients of an equation defining an elliptic curve are then selected, and a point P (having X and Y coordinates) on the elliptic curve. Once these terms are chosen, a point addition operation is defined, and from it a point multiplication operation is thereby defined, kP=P+P+P+ . . . +P (k times) i.e., P is added to itself P−1 times. With these terms, a private key consisting of one number, such as the number k, and a public key consisting of the product of the point P and the private key (the product being constrained by the finite field and the elliptic curve chosen) may be selected and used for public key cryptographic applications.

Multiplication or, more precisely, scalar multiplication is the dominant operation in elliptic curve cryptography. The speed at which multiplication can be done determines the performance of an elliptic curve method. Multiplication of a point P on an elliptic curve by an integer k may be realized by a series of additions (i.e., k*P =P+P+ . . . +P, where the number of Ps is equal to k). This is very easy to implement in hardware since only an elliptic adder is required, but it is very inefficient. That is, the number of operations is equal to k which may be very large.

The classical approach to elliptic curve multiplication is a double and add approach. For example, if a user wishes to realize k*P, where k=25 then 25 is first represented as a binary expansion of 25. That is, 25 is represented as a binary number 11001. Next, P is doubled a number of times equal to the number of bits in the binary expansion minus 1. For ease in generating an equation of the number of operations, the number of doubles is taken as m rather than m−1. The price for simplicity here is being off by 1. In this example, the doubles are 2P, 4P, 8P, and 16P. The doubles correspond to the bit locations in the binary expansion of 25 (i.e., 11001), except for the 1s bit. The doubles that correspond to bit locations that are then added along with P if the is bit is a 1. The number of adds equals the number of is in the binary expansion. In this example, there are three additions since there are three is in the binary expansion of 25 (i.e., 11001). So, 25P=16P+8P+P.

On average, there are m/2 1s in k. This results in m doubles and m/2 additions for a total of 3m/2 operations. Since the number of bits in k is always less than the value of k, the double and add approach requires fewer operations than does the addition method described above. Therefore, the double and add approach is more efficient (i.e., faster) than the addition approach.

Working on an elliptic curve allows smaller parameters relative to a modular arithmetic based system offering the same security. Thus, elliptic curve cryptography (ECC) is perceived as serious alternative to the RSA cryptography because ECC can use much shorter word lengths than RSA without sacrificing security. An ECC with a key size of 128-256 bits offers equal security as an RSA system having a key size of 1-2 Kbits. No significant breakthroughs have revealed weaknesses of ECC. The extreme difficult of solving the inverse discrete logarithm provides ECC with its advantage and enables ECC to secure information while using much smaller key sizes than other cryptography systems such as RSA. This advantage of ECCs has recently gained remarkable recognition, resulting in ECC being incorporated into many standards, including: IEEE, ANSI, NIST, SEC and WTLS.

However, for high-performance servers, conventional sequential scalar multiplication methods are too slow to meet the demands of the increasing number of customers. Identifying efficient scalar multiplication methods for such servers has become crucial. Scalar multiplication methods that can be parallelized are often used for high-speed implementations. Conventionally, precomputations have been applied to speed up scalar multiplication, but require sequential steps that cannot be parallelized, and are primarily advantageous when the elliptic-curve point is fixed. However, during secure communication sessions that use public keys, the elliptic-curve point changes, as it depends on the public key of the communicating entity, and hence it is session dependent. This is also the case when digital signatures are used. Therefore, the computation of scalar multiplications is generally performed with a generic elliptic-curve point. Because the elliptic-curve point is likely to differ in each session, the overheads resulting from the necessary precomputations must be considered when estimating the total computational time required.

The foregoing “background” description is for the purpose of generally presenting the context of the disclosure. Work of the inventor, to the extent it is described in this background section, as well as aspects of the description which may not otherwise qualify as prior art at the time of filing, are neither expressly or impliedly admitted as prior art against the present invention. The foregoing paragraphs have been provided by way of general introduction, and are not intended to limit the scope of the following claims. The described embodiments, together with further advantages, will be best understood by reference to the following detailed description taken in conjunction with the accompanying drawings.

### SUMMARY OF THE INVENTION

According to aspects of this disclosure, there is provided a method of scalar-point multiplication between a scalar (the key) and a point on an elliptic curve (the point), the method including: obtaining the key; partitioning the key into a plurality of key partitions; obtaining a plurality of precomputed points including precomputed points of the point; calculating, in parallel using a plurality of parallel processors, intermediate scalar products, wherein each of the intermediate scalar products is a scalar product between a key partition of the plurality of key partitions and a corresponding precomputed point of the point and the intermediate scalar products are calculated using a scalar-product method; and calculating a total scalar product by summing the intermediate scalar products.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a flow-chart of an embodiment of a parallel-scalar-multiplication method according to one example;

FIG. 2 shows a flow-diagram of an embodiment of a method of calculating, in parallel, an intermediate scalar product and then calculating a total scalar product according to one example; and

FIG. 3 shows an embodiment of computer hardware for performing a parallel-scalar-multiplication method according to one example; and

FIG. 4 shows an embodiment of a cryptography system according to one example.

### DETAILED DESCRIPTION

As an alternative to precomputations, postcomputations have recently been proposed as a method to speedup and parallelize scalar multiplications, as discussed in T. F. Al-Somani and M. K. Ibrahim, “Generic-point parallel-scalar multiplication without precomputations,” IEICE Electronics Express vol. 6, no. 24, pp. 1732-1736 (2009), incorporated herein by reference in its entirety. By substituting the overhead previously used for precomputations with postcomputations the scalar multiplication method can more effectively be parallelized. The key k is partitioned into u key partitions that can be processed in parallel by u processors using the binary method of scalar multiplication. Postcomputations are then distributed on u -1 processors to be performed in parallel. The points that result from processing these key partitions with the postcomputations are finally assimilated to produce k×P. The performance of the postcomputations-based method has been analyzed and the results show that high performance is achieved when eight cryptoprocessors are used with a key length of between 128 and 256.

The method described herein has performance advantages over the postcomputations-based method discussed above because it uses precomputations instead of postcomputations. However, unlike previous precomputations methods, the method described herein is able to parallelize the precomputations by performing precomputations on multiple points simultaneously. Thus, even though the precomputations for each point is performed serially through a series of point-doubling operations; the precomputations for each point are done win parallel with the precomputations of other points. By performing precomputations of u points on u parallel processors the resources of the parallel processors are efficiently utilized, as discussed in A. Al-Otaibi, T. F. Al-Somani, and P. Beckett, “Efficient elliptic curve parallel-scalar-multiplication methods,” 2013 8th International Conference on Computer Engineering & Systems (ICCES), pp. 116-123 (Nov. 26-28, 2013), incorporated herein by reference in its entirety.

In one embodiment, the method described herein is to calculate u scalar-point products P^{(m)}×k^{(m)} in parallel, where the superscript m on the point P^{(m)} and the key k^{(m)} is used to differentiate a particular scalar-point product. The parallel computation of u scalar-point products is realized by first performing u sequential precomputations on each of the u points on the elliptic curve (also referred to herein as the generic-points or simply as the points). While the precomputations are sequential for each generic-point, the sequential precomputations for each generic-point can be performed concurrently with simultaneous sequential precomputations of other generic points, each concurrent precomputation of using one of the u processors. These precomputations are performed in the first stage by mapping each generic-point P^{(m)} to a separate processor and then the designated processor performing point-doubling operations on the designated generic-point P^{(m)}. At intervals, the point-doublings of the generic-point P^{(m)} are recorded as the precomputed points Pᵢ^{(m)}. For example, the first precomputed point is always the generic-point with no point-doubling operations, i.e., P₀^{(m)}=P^{(m)}. If u is the number of processors and v×u is the length of the key, where v and u are both integers, then the second precomputed value will be the generic-point after v point-doubling operations, i.e., P₁^{(m)}=2^{v}P^{(m)}. The third precomputed value can be the value of the generic-point after 2v point-doubling operations, i.e., P₂^{(m)}=2^{2v}P^{(m)}, and so forth until a total of u precomputed points have been calculated for each generic-point. In one embodiment, because there are u generic-points each with u precomputed points, after the first stage there are a total of u² precomputed points.

In a second stage, the precomputed points Pᵢ^{(m)} are associated with corresponding key partitions k^{(m,i)} corresponding to partitioned segments of the keys k^{(m)}. Each scalar-point product P^{(m)}×k^{(m)} can be calculated as

$${P}^{( m )} \times {k}^{( m )} = {\sum }_{i = 0}^{u - 1} {k}^{( m , i )} \times {P}_{i}^{( m )} .$$

Thus, the problem of calculating the total scalar-point product P^{(m)}×k^{(m)} can be subdivided into calculating u intermediate scalar-point products k^{(m,i)}×Pᵢ^{(m)}. In a second stage, this subdivision of the scalar product is achieved by first partitioning each key k^{(m)} into u equally sized partitions k^{(m,i)} in order that the key partitions k^{(m,i)} can be processed in parallel by u processors. Each key partition has a length v, wherein v×u is the length of the key. Each partitions k^{(m,i)} is paired with a corresponding precomputed point Pᵢ^{(m,i)} and assigned to one of the processors, e.g., the i^{th} processor. The intermediate scalar-point product can then be calculated as the scalar product of the key-partition/precomputed-point pairs (k^{(m,i)},Pᵢ^{(m)}), which is computed in parallel by the u parallel processors to obtain intermediate scalar products k^{(m,i)}×Pᵢ^{(m)}. Finally, the intermediate scalar products k^{(m,i)}×Pᵢ^{(m)} are aggregated using point-addition operations to produce the total scalar product k^{(m)}P^{(m)}.

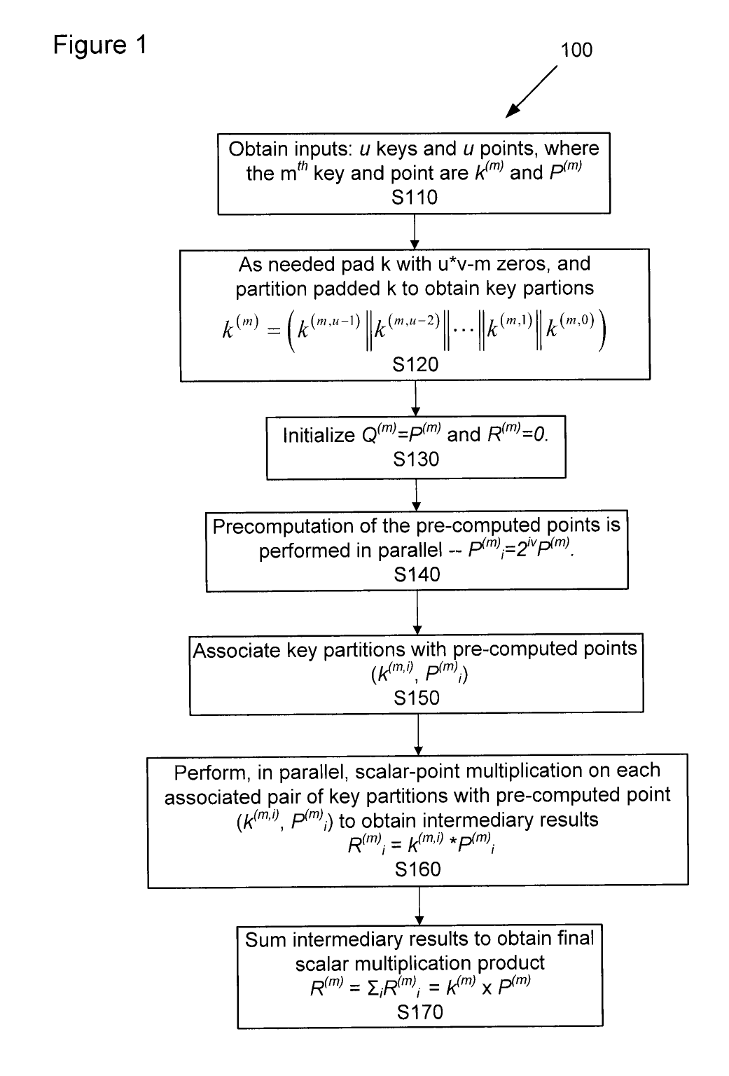

Referring now to the drawings, wherein like reference numerals designate identical or corresponding parts throughout the several views, FIG. 1 shows an exemplary implementation of a parallel-scalar-multiplication method 100 that performs parallel-scalar multiplication compatible with the demands of high-performance servers requiring fast speeds and high throughput. The exemplary implementation shown in FIG. 1 could be implemented via hardware, software, or a combination thereof. In the first step S110 of method 100, the keys k^{(m)and} the points P^{(m)} are obtained. The keys k^{(m)and} the points P^{(m)} are used in the scalar-point multiplication (also referred to as “scalar multiplication”), where the superscript (m) is used to differentiate among the several points and keys. For optimal operation the number of points P^{(m)} and keys k^{(m)} will be equal to the number of processors u.

Next, at step S120 of method 100, each key k^{(m)} is partitioned into u key partitions k^{(m,i)}, where i is the index of the key partitions. When the length of the key is not evenly divisible by u, zeroes can be padded to the most significant bit of the key in order to make the key evenly disable by u. The length of each key partition will be v, where the length of the padded key is given by the product u×v.

Next, at step S130 of method 100, the intermediate point doubling values Q^{(m)} and intermediate scalar products Rᵢ are respectively initialized to the values Rᵢ^{(m)}=0 and Q^{(m)}=P^{(m)}.

Next, at step S140 of method 100, precomputed points are calculated, using point-doubling operations. There are u precomputed points for each point P^{(m)}, which are given by

Pᵢ^{(m)}=2^{iv}P^{(m)} i=0,2, . . . ,u−1.

For one point P^{(m)} the computation of precomputed points requires v(u−1) point-doubling operations. In one implementation, each of the u processors is assigned to calculate precomputed points for one of a total of u points P^{(m)}. By performing the computations for each point in parallel, all precomputed points for the u points can be computed in the same time it takes to calculate precomputed points for a single point. Because there are u points and v(u−1) point-doubling operations per point, a total of uv(u−1) point-doubling operations are performed in step S140 of method 100.

Next, at step S150 of method 100, each precomputed point Pᵢ^{(m)} is associated with the corresponding key partition k^{(m,i)}. The precomputed points and key partitions are formed into pairs, which are given by (k^{(m,i)}, Pᵢ^{(m)}, and each of these pairs is respectively sent to one of the processors, e.g., the i^{th} processor, for further processing.

Next, at step S160 of method 100, the intermediate scalar products Rᵢ are calculated in parallel by the processors operating on precomputed-points/key-partition pairs (k^{(m,i)},Pᵢ^{(m)}). The intermediate scalar products are given by

Rᵢ^{(m)}=Pᵢ^{(m)}×k^{(m,i)}.

In one implementation, all of the intermediate scalar products for the m^{th} point are calculated in parallel by the u processors. Each of the u processors calculates a different intermediate scalar product (e.g., i^{th} processor calculates the i^{th} intermediate scalar product), so that all intermediate scalar products corresponding to the m^{th} point are calculated in parallel. After the intermediate scalar products of the m^{th} point are calculated, then the intermediate scalar products of the m+I^{th} point are calculated, and so forth, until all of the intermediate scalar products for all of the points are calculated. Thus, intermediate scalar products are calculated for all u points P^{(m)}. In one implementation the method of calculating the intermediate scalar products is the binary scalar multiplication method. However, any known scalar multiplication method can be used to calculate the intermediate scalar products. For example, any of the scalar multiplication methods discussed in D. Hankerson, A. J. Menezes, and S. Vanstone, Guide to Elliptic Curve Cryptography, Springer-Verlag (2004), incorporated herein by reference in its entirety, or in I. Blake, G. Seroussi and N. Smart, Elliptic Curves in Cryptography, Cambridge University Press, New York (1999), incorporated herein by reference in its entirety, can be used to calculate the intermediate scalar products. In the implementation where the binary method is used to calculate the intermediate scalar products, each intermediate scalar product calculation uses v−1 point addition operations and v−1 point-doubling operations. Thus, the total number of operations in step S160 for the m^{th} point is u(v−1) point addition operations and u(v−1) point-doubling operations, and for all u points the total number of operations in step S160 is u²(v−1) point addition operations and u²(v−1) point-doubling operations.

Next, at step S170 of method 100, each of the intermediate scalar products for the m^{th} point P^{(m)} is summed to obtain the scalar product k^{(m)}×P^{(m)}. This step is performed for each of the u points P^{(m)}. For each point the number of operations in step S170 is u−1 point addition operations, and for all u points the total number of operations in step S170 is u (u−1) point addition operations.

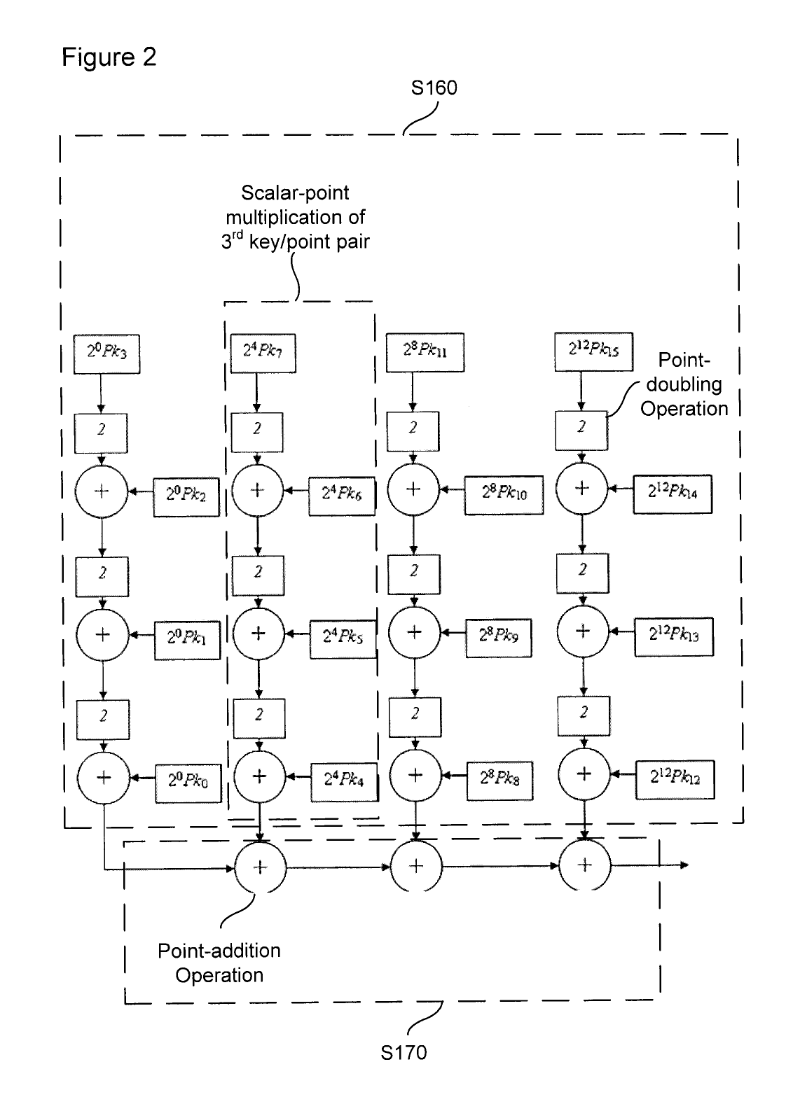

FIG. 2 shows an exemplary implementation steps 160 and S170 for method 100 for the case when u=4 and v=4. The exemplary implementation shown in FIG. 2 could be implemented via hardware, software, or a combination thereof. In FIG. 2, step S160 is performed using the binary scalar multiplication method. Each point-doubling operation is indicated by a rectangle designated by a “2” at its center, and each point-addition operation is indicated by a circle having a plus sign at its center. In FIG. 2 the precomputed points are given by P₀2 2⁰P, P₁=2⁴P, P₂=2⁸P, and P₃=2¹²P; and the key partitions are given by k⁽⁰⁾=(k₄,k₃,k₂,k₁), k⁽¹⁾=(k₈k₇,k₆,k₅), k⁽²⁾=(k₁₂,k₁₁,k₁₀,k₉), and k⁽³⁾=(k₁₆,k₁₅,k₁₄,k₁₃).

Pseudo code of method 100 is given below.

Pseudo code: method 100

| | |
|---|---|
| 1. | Inputs: P[0], P[1], ..., P[u − 1], k[0], k[1],..., k[u − 1]. |
| 2. | By padding the k's with (uv − m) zeros if necessary, write each k = |
| | (k^{(u - 1)} \|\| k^{(u - 2)} \|\| ... |
| | \|\| k⁽¹⁾ \|\| k⁽⁰⁾), where each k⁽ⁱ⁾ is a partition of length ^{ν = ┌m/u┐.} |
| 3. | Initialization: |
| | 3.1. For i = 0 to u − 1, do |
| | 3.1.1. Q[i] ← P[i] |
| | 3.1.2. R[i] ← O. |
| 4. | Perform concurrent precomputations of u points for each of the P's . |
| | 4.1. For i = 0 to u − 1, do in parallel |
| | 4.1.1. Pₒ[i] ← Q┌i┐. |
| | 4.2. For w = 0 to u − 1, do in parallel |
| | 4.2.1. for i = 1 to u − 1, do |
| | 4.2.1.1. for j = o to ν − 1, do |
| | 4.2.1.1.1. Q[w] ← 2Q[w], |
| | 4.2.1.2. Pᵢ[w] ← Q[w]. |
| 5. | Key partition association with precomputed points: |
| | 5.1. for i = 0 to u − 1 do |
| | 5.1.1. for j = 0 to u − 1 do |
| | 5.1.1.1. (k[i]^{(j)}, Pⱼ[i]) |
| 6. | Scalar multiplication: |
| | 6.1. for i = 0 to u − 1, do |
| | 6.1.1. for j = 0 to u − 1, do in parallel |
| | 6.1.1.1. Qⱼ[i] ← The Binary Method (k[i]^{(j)}, Pⱼ[i]), |
| | 6.1.1.2. R[i] ← R[i] + QⱼQⱼ[i]. |
| | 6.1.2. Output R[i]. |

As indicated in the pseudo code, in one implementation, method 100 accepts u requests, which means method 100 will calculate u scalar products between u points and u keys. For u requests, P[i] and k[i] respectively represent the point and the key of the i^{th} request. The partitioning of the keys into u partitions is performed in Step 2 of the pseudo code. For a particular key k[i], k[i]^{(j)} represents the j^{th} partition of the key k[i]. Precomputed points are computed concurrently for each point by repeated point-doubling operations in pseudo code Step 4. For a particular point P[i], Pⱼ[i] represents the i^{th} precomputed point corresponding to the j^{th} key partition.

The number of required precomputed points is u for each point. For a particular P[i] and [i], each partition k[i]^{(j)} is associated with a particular precomputed point Pⱼ[i] (pseudo code Step 5). For a particular P[i] and k[i], parallel-scalar multiplications is performed in pseudo code Step 6 of the pseudo code, wherein j^{th} processor computes the scalar product corresponding to the j^{th} key partition and precomputed point. These scalar products between the j^{th} key partition and precomputed point are the intermediate scalar products Q[i]. In pseudo code step 6, the intermediate scalar products Qⱼ[i] are obtained using the binary method. The intermediate scalar products are computed in parallel for all of the key partitions associated with the same key. For example, all of the intermediate scalar products Qⱼ[i] are calculated for the key partitions k[i]^{(j)} associated with the i^{th} key k[i], and then the intermediate scalar products Qⱼ[i+l] are calculated for the key partitions associated with the i+1^{th} key, and so forth until all intermediate scalar products are calculated. As shown in the pseudo code, pseudo code step 6 also includes that after each calculation of an intermediate scalar product Qⱼ[i], the intermediate scalar product is immediately summed to the total e scalar product R[i]. In an alternative implementation, there may be undesired communication overhead between the processors associated with immediately summing the intermediate scalar product to the total scalar product because each intermediate scalar product is calculated by a separate processor, and immediately summing the intermediate scalar product requires coordination and communication among processors resulting in inefficiencies. Therefore, in an alternative implementation to the pseudo code, the intermediate scalar products can be stored during the parallel processing of intermediate scalar products, and then after all of the intermediate scalar products are computed and collected at a single processor, the intermediate scalar products can be summed to obtain the total scalar products.

The method described herein improves performance over conventional scalar-product algorithms by parallelizing the scalar product computation using multiple processors. This can be especially advantageous going forward as trends in modern computing continue towards increasing the number of processors rather than increasing the speed of each processor. Thus, method 100 is compatible with high-performance servers, wherein conventional sequential scalar multiplication methods are too slow to meet the demands of the increasing number of customers. Method 100 has a higher throughput than conventional scalar-product algorithms because multiple scalar-products are calculated together. Thus, the time required to calculate multiple scalar products is only slightly greater than the time required to calculate a single scalar product. In particular, all of the intermediate scalar products associated with a given key and point are calculated in parallel, increasing the speed of the intermediate scalar products calculation proportional to the number of processors. Similarly, by parallelizing the precomputations of precomputed points, method 100 also improves the throughput of the precomputations step. Therefore, method 100 provides the method of calculating scalar products that achieves improved performance of cyrptosystems using multiple processors.

Next is provided an example of method 100 using two processors (i.e., u=2). In the example, two points provided P₀ and P₁, but only a single key k is provided. Thus, the two scalar products calculated in the example are P₀×k and P₁×k.

Example: Let k=(1000 0101 1100 0011)₂=(34243)₁₀, m=16, u=2. The key partitions are k⁽⁰⁾=1100 0011 and k⁽¹⁾=1000 0101. The scalar multiplication of these partitions is then computed in parallel for two consecutive requests, using the same key for simplicity and two different points (P₀ and P₁), as:
Stage (1): Concurrent Precompuatations Stage.

Processor₍₀₎: Precompute the required point for P₀, which is P₀[8].

Processor₍₁₎: Precompute the required point for P₁, which is P₁[8]
Stage (2): Processing Stage.

1. Processing the 1^{st} request (kP₀)
Processor₍₀₎ s_{0,P}_{₀}=[2(2(2(2(2(2(2(1)P₀+(1)P₀)+(0)P₀)+(0)P₀)+(0)P₀)+(0)P₀)+(1)P₀)+(1)P₀]=195P⁰.
Processor₍₁₎ s_{1,P}_{₀}=[2(2(2(2(2(2(2(1)P₀[8]+(0)P₀[8])+(0)P₀[8])+(0)P₀[8])+(0)P₀[8])+(1)P₀[8])+(0)P₀[8])+(1)P=34048P₀.
Accordingly, kP₀ is computed as: kP₀=s_{0,P}_{₀}+s_{1,P}_{₀}=195P₀+34048P₀=34243P₀.

2. Processing the 2^{nd} request (kP₁)
Processor₍₀₎ s_{0,P}_{₁}=[2(2(2(2(2(2(2(1)P₁+(1)P+(0)P₁)+(0)/P₁)+(0)/P₁)+(0)P₁)+(1)P₁)+(1)P₁]=195P₁.

Processor₍₁₎ s_{1,P}_{₁}=[2(2(2(2(2(2(2(1)P₁[8]+(0)P₁[8])+(0)P₁[0 +(0)P₁[8])+(0)P₁[8])+(1)P₁[8])+(0)P₁[8])+(1)P=195P₁

Accordingly, kP₁ is computed as:

kP₁=s_{0,P}_{₁}+s_{1,P}_{₁}=195P₁+34048P₁=34243P₁.

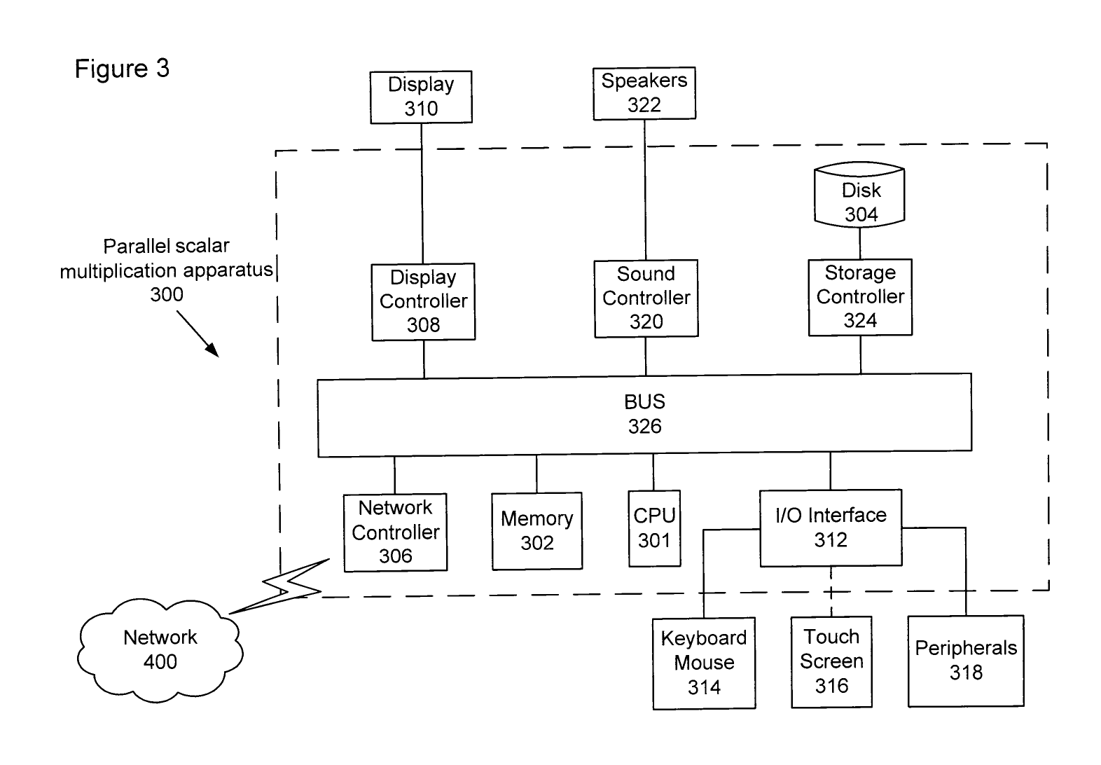

Next, a hardware description of the parallel scalar-multiplication apparatus 300 according to exemplary embodiments is described with reference to FIG. 3. In FIG. 3, the parallel scalar-multiplication apparatus 300 includes a CPU 301 which performs the processes described above. The process data and instructions may be stored in memory 302. These processes and instructions may also be stored on a storage medium disk 304 such as a hard disk drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the parallel scalar-multiplication apparatus 300 communicates, such as a server or computer.

Further, the claimed advancements may be provided as a utility application, background daemon, or component of an operating system, or combination thereof, executing in conjunction with CPU 301 and an operating system such as Microsoft Windows 7, UNIX, Solaris, LINUX, Apple MAC-OS and other systems known to those skilled in the art.

CPU 301 may be a Xenon or Core processor from Intel of America or an Opteron processor from AMD of America, or may be other processor types that would be recognized by one of ordinary skill in the art. Alternatively, the CPU 301 may be implemented using a GPU processor such as a Tegra processor from Nvidia Corporation and an operating system, such as Multi-OS. Moreover, the CPU 301 may be implemented on an FPGA, ASIC, PLD or using discrete logic circuits, as one of ordinary skill in the art would recognize. Further, CPU 301 may be implemented as multiple processors cooperatively working in parallel to perform the instructions of the inventive processes described above.

The parallel scalar-multiplication apparatus 300 in FIG. 3 also includes a network controller 306, such as an Intel Ethernet PRO network interface card from Intel Corporation of America, for interfacing with network 398. As can be appreciated, the network 398 can be a public network, such as the Internet, or a private network such as an LAN or WAN network, or any combination thereof and can also include PSTN or ISDN sub-networks. The network 398 can also be wired, such as an Ethernet network, or can be wireless such as a cellular network including EDGE, 3G and 4G wireless cellular systems. The wireless network can also be WiFi, Bluetooth, or any other wireless form of communication that is known.

The Parallel scalar-multiplication apparatus 300 further includes a display controller 308, such as a NVIDIA GeForce GTX or Quadro graphics adaptor from NVIDIA Corporation of America for interfacing with display 310, such as a Hewlett Packard HPL2445w LCD monitor. A general purpose I/O interface 312 interfaces with a keyboard and/or mouse 314 as well as a touch screen panel 316 on or separate from display 310. General purpose I/O interface also connects to a variety of peripherals 318 including printers and scanners, such as an OfficeJet or DeskJet from Hewlett Packard.

A sound controller 320 is also provided in the parallel scalar-multiplication apparatus, such as Sound Blaster X-Fi Titanium from Creative, to interface with speakers/microphone 322 thereby providing sounds and/or music.

The general purpose storage controller 324 connects the storage medium disk 304 with communication bus 326, which may be an ISA, EISA, VESA, PCI, or similar, for interconnecting all of the components of the Parallel scalar-multiplication apparatus. A description of the general features and functionality of the display 310, keyboard and/or mouse 314, as well as the display controller 308, storage controller 324, network controller 306, sound controller 320, and general purpose I/O interface 312 is omitted herein for brevity as these features are known.

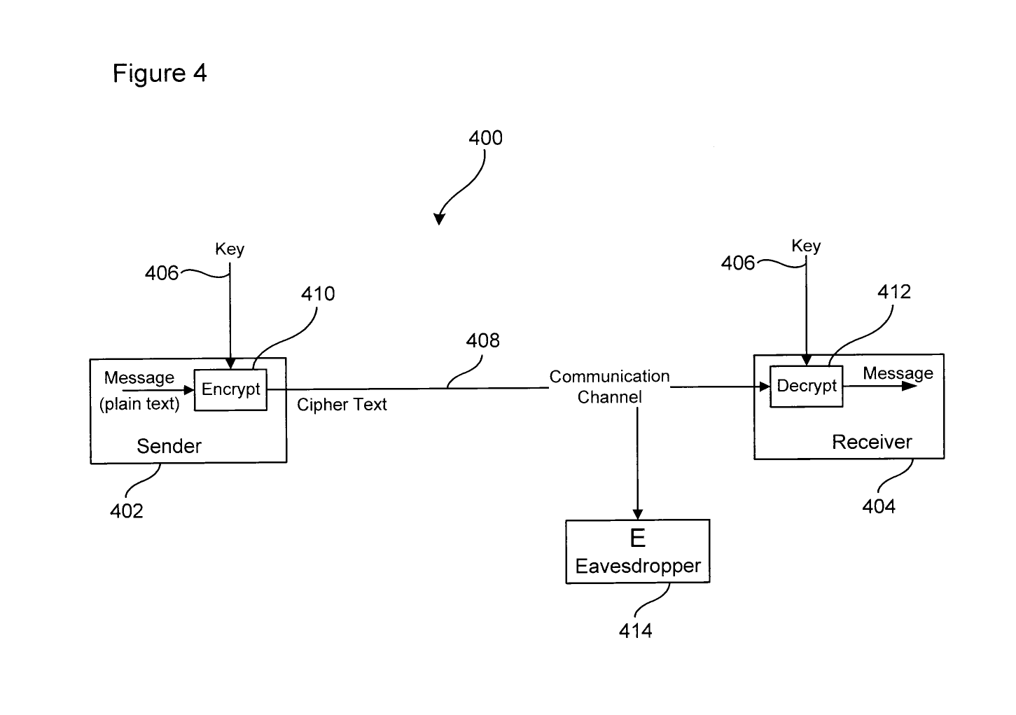

The parallel scalar-multiplication apparatus 300 can be used by the sender, receiver, or both as part of a larger cryptosystem 400 shown in FIG. 4. The parallel scalar-multiplication apparatus 300 is used to calculate the scalar product of performing cryptographic communication using the disclosed parallel-scalar-multiplication method 100 is shown in FIG. 4.

The computational hardware disclosed in FIG. 3 can be used by both the sender 402 and the receiver 404 in order to generate a shared cryptographic key by performing scalar multiplications. Either the Diffie-Hellman scheme, ElGamal scheme, or the like can be used to create the shared cryptographic key.

In an implementation of the cryptosystem 400, the network includes two communication nodes: a sender 402 and a receiver 404. Both the receiver and the sender can use the parallel scalar-multiplication apparatus 300 to perform scalar multiplications. First, the sender 402 and receiver 404 agree on the parameters of an elliptical curve and a generator (the base point). The sender 402 and receiver 404 each choose a respective private key and each calculate a respective public key, which is the scalar product between the generator and their respective private key. Next, the sender 402 and receiver 404 exchange their public keys via the unsecure communication channel 408, and each calculates a shared key 406 by calculating the scalar product between the received public key and the private key. Having calculated the shared key 406, the sender 402 can use the encryption circuitry 410 with the key 406 to encrypt a plain text message in order to obtain cypher text message that is transmitted through the communication channel 408 to the receiver 404. Using the key 406, the receiver 404 can then decrypt 412 the cypher text message to retrieve the plain text message.

Although the eavesdropper 414 may have access to the elliptic curve parameters, the generator, and the public keys, the eavesdropper cannot decipher the cipher text without knowledge of the shared key 406. Thus, the security of the cryptographic methods relies on the asymmetry that calculating the shared key 406 is mathematically difficult and time consuming for the eavesdropper 414 while it is simple for the sender and receiver given their knowledge of one of the private keys. In elliptic curve cryptography the mathematically difficult problem the eavesdropper must solve is the elliptic curve discrete logarithm problem. The difficulty of solving the elliptic curve discrete logarithm provides security against direct attacks, like that shown in FIG. 4.

While certain implementations have been described, these implementations have been presented by way of example only, and are not intended to limit the teachings of this disclosure. Indeed, the novel methods, apparatuses and systems described herein may be embodied in a variety of other forms; furthermore, various omissions, substitutions and changes in the form of the methods, apparatuses and systems described herein may be made without departing from the spirit of this disclosure.

The above disclosure also encompasses the embodiments listed below.

(1) A method of parallel-scalar multiplication that includes obtaining a key; partitioning the key into a plurality of key partitions; obtaining a plurality of precomputed points including precomputed points of a point; calculating, in parallel using a plurality of parallel processors, a plurality of intermediate scalar products, wherein each of the intermediate scalar products is a scalar product between a key partition of the plurality of key partitions and a corresponding precomputed point of the point, and each of the plurality of intermediate scalar products is calculated using a scalar-product method; and calculating a total scalar product by summing the plurality of intermediate scalar products.

(2) The method of (1), wherein the scalar-product method used to calculate the plurality of intermediate scalar products is a binary scalar-product method.

(3) The method of (1) or (2), wherein the number of key partitions equals the number of processors in the plurality of parallel processors; and the number of precomputed points of the point included in the plurality of precomputed points is equal to the number of processors in the plurality of parallel processors.

(4) The method of any one of (1) to (3), wherein the calculation of the total scalar product is performed by summing the plurality of intermediate scalar products using a first processor of the plurality of parallel processors.

(5) The method of any one of (1) to (4), further including: calculating, in parallel using the plurality of parallel processors, the plurality of precomputed points by performing point-doubling operations on a plurality of points including the point, wherein the plurality of points further includes another point, and a first processor of the plurality of parallel processors computes the precomputed points of the point in parallel with a second processor of the plurality of parallel processors computing the precomputed points of the another point.

(6) The method of any one of (1) to (5), further c including: calculating another scalar product in parallel with the scalar product of the point and the key, wherein the another scalar product is a scalar product between the another point and another key.

(7) The method of any one of (1) to (6), wherein the step of calculating the another scalar product includes partitioning the another key into another plurality of key partitions, calculating, in parallel using the plurality of parallel processors, another plurality of intermediate scalar products, wherein each of the intermediate scalar products of the another plurality of intermediate scalar products is a scalar product between a key partition of the another plurality of key partitions and a corresponding precomputed point of the another point, and the another plurality of intermediate scalar products is calculated using the scalar-product method, and calculating another total scalar product that is a sum of the another plurality of intermediate scalar products.

(8) The method of any one of (1) to (7), wherein the step of calculating the another scalar product includes calculating the precomputed points of the point using the first processor of the plurality of parallel processors, and calculating, in parallel, the precomputed points of the another point using the second processor of the plurality of parallel processors, and calculating the another plurality of intermediate scalar products either before or after the calculation of the plurality of intermediate scalar products.

(9) A cryptography scalar multiplication that includes processing circuitry including a plurality of parallel processors. The processing circuitry is configured to obtain a key; partition the key into a plurality of key partitions; obtain a plurality of precomputed points including precomputed points of a point; calculate, in parallel using the plurality of parallel processors, plurality of intermediate scalar products, wherein each of the intermediate scalar products is a scalar product between a key partition of the plurality of key partitions and a corresponding precomputed point of the point and the plurality of intermediate scalar products is calculated using a scalar-product method; and calculate a total scalar product by summing the plurality of intermediate scalar products.

(10) The cryptography apparatus of (9), wherein the processing circuitry is further configured to calculate, in parallel, the plurality of intermediate scalar products using a binary scalar-product method.

(11) The cryptography apparatus of (9) or (10), wherein the processing circuitry is further configured to partition the key into the plurality of key partitions, wherein the number of key partitions equals the number of processors in the plurality of parallel processors; and obtain the plurality of precomputed points, wherein the number of precomputed points of the point equals to the number of processors in the plurality of parallel processors.

(12) The cryptography apparatus of any one of (9) to (11), wherein the processing circuitry is further configured to calculate, in parallel, the plurality of precomputed points by performing point-doubling operations on a plurality of points including the point, wherein the plurality of points further includes another point, and a first processor of the plurality of parallel processors computes the precomputed points of the point in parallel with a second processor of the plurality of parallel processors computing the precomputed points of the another point.

(13) The cryptography apparatus of any one of (9) to (12), wherein the processing circuitry is further configured to calculate the total scalar product by summing the plurality of intermediate scalar products using a first processor of the plurality of parallel processors.

(14) The cryptography apparatus of any one of (9) to (13), wherein the processing circuitry is further configured to calculate another scalar product in parallel with the scalar product of the point and the key, wherein the another scalar product is a scalar product between the another point and another key.

(15) The cryptography apparatus of any one of (9) to (14), wherein the processing circuitry is further configured to calculate the another scalar product by partitioning the another key into another plurality of key partitions; calculating, in parallel using the plurality of parallel processors, another plurality of intermediate scalar products, wherein each of the intermediate scalar products of the another plurality of intermediate scalar products is a scalar product between a key partition of the another plurality of key partitions and a corresponding precomputed point of the another point and the another plurality of intermediate scalar products is calculated using the scalar-product method; and calculating another total scalar product that is a sum of the another plurality of intermediate scalar products.

(16) The cryptography apparatus of any one of (9) to (15), wherein the processing circuitry is further configured to calculate the another scalar product by calculating the precomputed points of the point using the first processor of the plurality of parallel processors, and calculating, in parallel, the precomputed points of the another point using the second processor of the plurality of parallel processors, and calculating the another plurality of intermediate scalar products either before or after the calculation of the plurality of intermediate scalar products.

(17) A parallelized elliptic curve cryptography system that includes a first communication node configured to encrypt a signal using a scalar product of a point and a key, and transmit the encrypted signal; and a second communication node configured to receive the encrypted signal, decrypt the encrypted signal, using the scalar product of the point and the key, and calculate the scalar product of the point and the key, using processing circuitry having a plurality of parallel processors. The processing circuitry is configured to partition the key into a plurality of key partitions; and obtain a plurality of precomputed points including precomputed points of the point, wherein the precomputed points of the point are point-doublings of the point. The processing circuitry is further configured to calculate, in parallel using the plurality of parallel processors, plurality of intermediate scalar products that are each a scalar product between a key partition of the key and a corresponding precomputed point of the point, wherein the plurality of intermediate scalar products is calculated using a scalar-product method; and calculate a total scalar product by summing the plurality of intermediate scalar products.

(18) The parallelized elliptic curve cryptography system of (17), wherein the processing circuitry is further configured to calculate, in parallel, the plurality of intermediate scalar products using a binary scalar-product method; partition the key into the plurality of key partitions, wherein the number of key partitions equals the number of processors in the plurality of parallel processors; obtain the plurality of precomputed points wherein the number of precomputed points of the point equals the number of processors in the plurality of parallel processors; and calculate the total scalar product by summing the plurality of intermediate scalar products using a first processor of the plurality of parallel processors.

(19) The parallelized elliptic curve cryptography system of (17) or (18), wherein the processing circuitry is further configured to calculate, in parallel using the plurality of parallel processors, the plurality of precomputed points by performing point-doubling operations on a plurality of points including the point, wherein the plurality of points further includes another point, and a first processor of the plurality of parallel processors computes the precomputed points of the point in parallel with a second processor of the plurality of parallel processors computing the precomputed points of the another point. The processing circuitry is further configured to calculate another scalar product in parallel with the scalar product of the point and the key, wherein the another scalar product is a scalar product between the another point and another key by partitioning the another key into another plurality of key partitions; calculating, in parallel using the plurality of parallel processors, another plurality of intermediate scalar products, wherein each of the intermediate scalar products of the another plurality of intermediate scalar products is a scalar product between a key partition of the another plurality of key partitions and a corresponding precomputed point of the another point, the another plurality of intermediate scalar products is calculated using a scalar-product method; and calculating another total scalar product by summing the another plurality of intermediate scalar products.

(20) A non-transitory computer-readable medium storing executable instructions, wherein the instructions, when executed by processing circuitry, cause the processing circuitry to perform the method of obtaining a plurality of precomputed points including precomputed points of a point; calculating, in parallel using a plurality of parallel processors, a plurality of intermediate scalar products, wherein each of the intermediate scalar products is a scalar product between a key partition of the plurality of key partitions and a corresponding precomputed point of the point, and each of the plurality of intermediate scalar products is calculated using a scalar-product method; and calculating a total scalar product by summing the plurality of intermediate scalar products.

1. A method of parallel-scalar multiplication, comprising:
obtaining a key;
partitioning the key into a plurality of key partitions;
obtaining a plurality of precomputed points including precomputed points of a point;
calculating, in parallel using a plurality of parallel processors, a plurality of intermediate scalar products, wherein each of the intermediate scalar products is a scalar product between a key partition of the plurality of key partitions and a corresponding precomputed point of the point, and each of the plurality of intermediate scalar products is calculated using a scalar-product method; and
calculating a total scalar product by summing the plurality of intermediate scalar products.

2. The method according to claim 1, wherein the scalar-product method used to calculate the plurality of intermediate scalar products is a binary scalar-product method.

3. The method according to claim 1, wherein
the number of key partitions equals the number of processors in the plurality of parallel processors; and
the number of precomputed points of the point included in the plurality of precomputed points is equal to the number of processors in the plurality of parallel processors.

4. The method according to claim 1, wherein the calculation of the total scalar product is performed by summing the plurality of intermediate scalar products using a first processor of the plurality of parallel processors.

5. The method according to claim 1, further comprising:
calculating, in parallel using the plurality of parallel processors, the plurality of precomputed points by performing point-doubling operations on a plurality of points including the point, wherein
the plurality of points further includes another point, and
a first processor of the plurality of parallel processors computes the precomputed points of the point in parallel with a second processor of the plurality of parallel processors computing the precomputed points of the another point.

6. The method according to claim 5, further comprising:
calculating another scalar product in parallel with the scalar product of the point and the key, wherein the another scalar product is a scalar product between the another point and another key.

7. The method according to claim 6, wherein the step of calculating the another scalar product includes
partitioning the another key into another plurality of key partitions,
calculating, in parallel using the plurality of parallel processors, another plurality of intermediate scalar products, wherein each of the intermediate scalar products of the another plurality of intermediate scalar products is a scalar product between a key partition of the another plurality of key partitions and a corresponding precomputed point of the another point, and the another plurality of intermediate scalar products is calculated using the scalar-product method, and
calculating another total scalar product that is a sum of the another plurality of intermediate scalar products.

8. The method according to claim 7, wherein the step of calculating the another scalar product includes
calculating the precomputed points of the point using the first processor of the plurality of parallel processors, and calculating, in parallel, the precomputed points of the another point using the second processor of the plurality of parallel processors, and
calculating the another plurality of intermediate scalar products either before or after the calculation of the plurality of intermediate scalar products.

9. A cryptography scalar multiplication, comprising:
processing circuitry including a plurality of parallel processors, the processing circuitry configured to
obtain a key;
partition the key into a plurality of key partitions;
obtain a plurality of precomputed points including precomputed points of a point;
calculate, in parallel using the plurality of parallel processors, plurality of intermediate scalar products, wherein each of the intermediate scalar products is a scalar product between a key partition of the plurality of key partitions and a corresponding precomputed point of the point and the plurality of intermediate scalar products is calculated using a scalar-product method; and
calculate a total scalar product by summing the plurality of intermediate scalar products.

10. The cryptography apparatus according to claim 9, wherein the processing circuitry is further configured to calculate, in parallel, the plurality of intermediate scalar products using a binary scalar-product method.

11. The cryptography apparatus according to claim 9, wherein the processing circuitry is further configured to
partition the key into the plurality of key partitions, wherein the number of key partitions equals the number of processors in the plurality of parallel processors; and
obtain the plurality of precomputed points, wherein the number of precomputed points of the point equals to the number of processors in the plurality of parallel processors.

12. The cryptography apparatus according to claim 9, wherein the processing circuitry is further configured to
calculate, in parallel, the plurality of precomputed points by performing point-doubling operations on a plurality of points including the point, wherein
the plurality of points further includes another point, and
a first processor of the plurality of parallel processors computes the precomputed points of the point in parallel with a second processor of the plurality of parallel processors computing the precomputed points of the another point.

13. The cryptography apparatus according to claim 9, wherein the processing circuitry is further configured to calculate the total scalar product by summing the plurality of intermediate scalar products using a first processor of the plurality of parallel processors.

14. The cryptography apparatus according to claim 12, wherein the processing circuitry is further configured to
calculate another scalar product in parallel with the scalar product of the point and the key, wherein the another scalar product is a scalar product between the another point and another key.

15. The cryptography apparatus according to claim 14, wherein the processing circuitry is further configured to calculate the another scalar product by
partitioning the another key into another plurality of key partitions;
calculating, in parallel using the plurality of parallel processors, another plurality of intermediate scalar products, wherein each of the intermediate scalar products of the another plurality of intermediate scalar products is a scalar product between a key partition of the another plurality of key partitions and a corresponding precomputed point of the another point and the another plurality of intermediate scalar products is calculated using the scalar-product method; and
calculating another total scalar product that is a sum of the another plurality of intermediate scalar products.

16. The cryptography apparatus according to claim 15, wherein the processing circuitry is further configured to calculate the another scalar product by
calculating the precomputed points of the point using the first processor of the plurality of parallel processors, and calculating, in parallel, the precomputed points of the another point using the second processor of the plurality of parallel processors, and
calculating the another plurality of intermediate scalar products either before or after the calculation of the plurality of intermediate scalar products.

17. A parallelized elliptic curve cryptography system, comprising:
a first communication node configured to encrypt a signal using a scalar product of a point and a key, and transmit the encrypted signal; and
a second communication node configured to receive the encrypted signal, decrypt the encrypted signal, using the scalar product of the point and the key, and calculate the scalar product of the point and the key, using processing circuitry having a plurality of parallel processors, the processing circuitry configured to
partition the key into a plurality of key partitions;
obtain a plurality of precomputed points including precomputed points of the point, wherein the precomputed points of the point are point-doublings of the point;
calculate, in parallel using the plurality of parallel processors, plurality of intermediate scalar products that are each a scalar product between a key partition of the key and a corresponding precomputed point of the point, wherein the plurality of intermediate scalar products is calculated using a scalar-product method; and
calculate a total scalar product by summing the plurality of intermediate scalar products.

18. The parallelized elliptic curve cryptography system according to claim 17, wherein the processing circuitry is further configured to
calculate, in parallel, the plurality of intermediate scalar products using a binary scalar-product method;
partition the key into the plurality of key partitions, wherein the number of key partitions equals the number of processors in the plurality of parallel processors;
obtain the plurality of precomputed points wherein the number of precomputed points of the point equals the number of processors in the plurality of parallel processors; and
calculate the total scalar product by summing the plurality of intermediate scalar products using a first processor of the plurality of parallel processors.

19. The parallelized elliptic curve cryptography system according to claim 17, wherein the processing circuitry is further configured to
calculate, in parallel using the plurality of parallel processors, the plurality of precomputed points by performing point-doubling operations on a plurality of points including the point, wherein the plurality of points further includes another point, and a first processor of the plurality of parallel processors computes the precomputed points of the point in parallel with a second processor of the plurality of parallel processors computing the precomputed points of the another point; and
calculate another scalar product in parallel with the scalar product of the point and the key, wherein the another scalar product is a scalar product between the another point and another key by
partitioning the another key into another plurality of key partitions;
calculating, in parallel using the plurality of parallel processors, another plurality of intermediate scalar products, wherein each of the intermediate scalar products of the another plurality of intermediate scalar products is a scalar product between a key partition of the another plurality of key partitions and a corresponding precomputed point of the another point, the another plurality of intermediate scalar products is calculated using a scalar-product method; and
calculating another total scalar product by summing the another plurality of intermediate scalar products.

20. A non-transitory computer-readable medium storing executable instructions, wherein the instructions, when executed by processing circuitry, cause the processing circuitry to perform the method according to claim 1.
